(19) United States
(12) Patent Application Publication
(10) Pub. No.: US 2025/0319595 A1
(43) Pub. Date: Oct. 16, 2025

(54) ROBOT END OF ARM TOOL HEALTH- GRIPPER TIMING

(71) Applicant: FANUC AMERICA CORPORATION, Rochester Hills, MI (US)

(72) Inventors: Ganesh Kalbavi, Rochester, MI (US); Kyler Koets, Holly, MI (US); Yi Sun, Bloomfield Hills, MI (US)

(21) Appl. No.: 18/631,164

(22) Filed: Apr. 10, 2024

(51) Int. Cl. B25J 9/16; B25J 13/08

(52) U.S. Cl. CPC B25J 9/1674; B25J 9/1612; B25J 9/1697; B25J 13/082

(57) ABSTRACT

A method and system for proactively monitoring the health of a robot end-of-arm tool based on timing of response to gripping commands. A part presence or other sensor provides a signal when a robot tool successfully grips or ungrips a workpiece. The time between each grip or ungrip command and its completion is recorded by the robot controller. Timing data for all robots in a facility are collected by a data collection device and forwarded to an analytic data center, where the timing data is analyzed for each end-of-arm tool. Alerts are sent advising of issues which have been identified on grippers when grip times exceeding a threshold or a deterioration trend in grip time performance is detected, and all analytic data is provided to a web portal for customer viewing and action. Response timing for other types of end-of-arm tools besides grippers may be similarly analyzed for proactive tool repair/replacement.

### BACKGROUND

### Field

The present disclosure relates to the field of industrial robot gripper performance and, more particularly, to a method and system for proactively monitoring the health of a robot end-of-arm tool based on timing of response to gripping commands, where the timing data is collected and analyzed for each end-of-arm tool, and alerts are sent advising preventive maintenance be performed on grippers when grip times exceeding a threshold or a deterioration trend in grip time performance is detected.

### Discussion of the Related Art

The use of industrial robots to perform a wide range of manufacturing, assembly and material movement operations is well known. Many operations performed by industrial robots involve the use of a gripper to grasp a part and move the part from one location or orientation to another. These grippers—which are part of a large family of devices known generically as end-of-arm tools—may be in the form of suction cup grippers, mechanical finger-type grippers, or servo-controlled grippers, among others.

Like any other type of mechanical component, end-of-arm tools are susceptible to wear and tear leading to an eventual degradation in performance and/or outright failure. Until now, it has been common practice to simply replace grippers when they fail—that is, when they fail to pick up parts or drop parts due to breakage or jamming of a mechanical component, or a leak in a vacuum line or suction cup, for example. Unfortunately, end-of-arm tool failures require a production operation to be shut down for repair or replacement of the failed device. This system downtime is costly to the robot operator, as production time is lost, and the repair or replacement may require parts or a service technician which are not readily available—further lengthening the downtime and/or necessitating expedited part shipments, overtime, etc.

In light of the circumstances described above, there is a need for a robot end-of-arm tool health monitoring technique which can proactively identify deterioration in gripper performance and enable preventive maintenance to be performed before end-of-arm tool failure causes a production line shutdown.

### SUMMARY

In accordance with the teachings of the present disclosure, a method and system are disclosed for proactively monitoring the health of a robot end-of-arm tool based on timing of response to gripping commands. A part presence sensor such as a photoeye, vacuum switch or other type of sensor provides a signal when a robot gripper tool successfully grips or ungrips a workpiece. The time between each grip or ungrip command and its completion is recorded by the robot controller. Timing data for all robots in a facility are collected by a data collection device and forwarded to an analytic data center, where the timing data is analyzed for each end-of-arm tool. Alerts are sent advising of issues which have been identified on grippers when grip times exceeding a threshold or a deterioration trend in grip time performance is detected, and all analytic data is provided to a web portal for customer viewing and action. Response timing for other types of end-of-arm tools besides grippers may be similarly analyzed for proactive tool repair or replacement.

### BRIEF DESCRIPTION OF THE DRAWINGS

FIG. 1 is an illustration of an industrial robot fitted with a mechanical gripper style end-of-arm tool;

FIG. 2 is an illustration of an industrial robot fitted with a suction cup style end-of-arm tool;

FIG. 3 is an illustration of a vacuum gripper tool comprising a suction cup grid which may be used as a robot end-of-arm tool;

FIG. 4 is an illustration of a system for proactively monitoring the health of robot end-of-arm tools based on timing of response to gripping commands, according to an embodiment of the present disclosure;

FIG. 5 is a flowchart diagram of a method for proactively monitoring the health of robot end-of-arm tools based on timing of response to gripping commands, according to an embodiment of the present disclosure; and

FIG. 6 is a flowchart diagram of a method for identifying any issues with the health of robot end-of-arm tools based on analysis of gripping command response timing data, according to an embodiment of the present disclosure.

### DETAILED DESCRIPTION OF THE EMBODIMENTS

The following discussion of the embodiments of the disclosure directed to robot end-of-arm tool health monitoring via gripper timing is merely exemplary in nature, and is in no way intended to limit the disclosed devices and techniques or their applications or uses.

It is well known to use industrial robots for a variety of manufacturing, assembly and material movement operations. Many operations performed by industrial robots involve the use of a gripper to grasp a part and move the part from one location and orientation to another. These grippers may be in the form of suction cup grippers, mechanical finger-type grippers, or servo-controlled grippers, among others. Grippers are one type of end-of-arm tool which may be fitted to the end of an outer robot arm—typically at the end of a wrist joint.

FIG. 1 is an illustration of an industrial robot fitted with a mechanical gripper style end-of-arm tool. A robot 100 is controlled by a controller 110 to perform an operation in a manner known in the art. The controller 110 communicates with the robot 100 via a cable 112. In FIG. 1, the robot 100 is fitted with a mechanical finger-style gripper 120 which is used to grasp a part or workpiece 130 from an initial position and pose and place the workpiece 130 at a target position in a target pose. The initial position may be on a conveyor, and the final position in a shipping container, for example.

The mechanical finger-style gripper 120 may have two or more grasping fingers, depending on the application and the nature of the workpiece 130 which is being grasped. The mechanical finger-style gripper 120 commonly includes a simple actuator (such as pneumatic) to move the fingers of the gripper 120 to an open or closed position. A part presence sensor 122 is used to detect the presence or absence of a part in the gripper. Another style of gripper-known as a servo-controlled gripper—also has mechanical fingers, but uses a servo motor to open and close the fingers, where the servo motor can be precisely controlled to adjust the opening width and the grasping pressure of the fingers. In the case of servo-controlled grippers, torque sensors or encoders can serve as a part presence sensor.

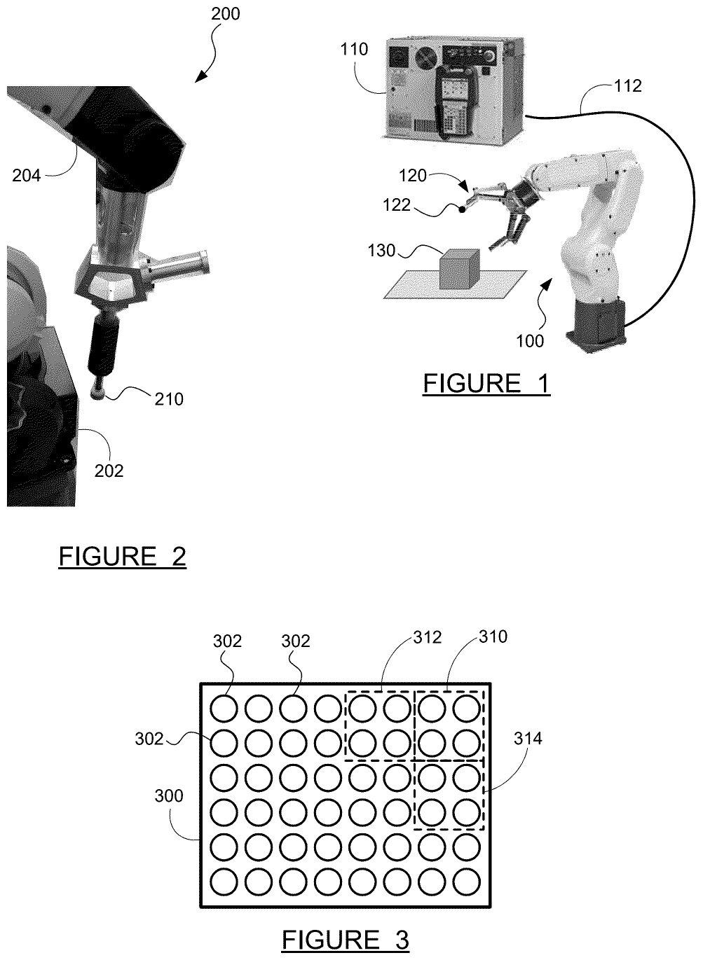

FIG. 2 is an illustration of an industrial robot fitted with a suction cup style end-of-arm tool. A robot 200 includes a base 202 and an outer arm 204. Other arms of the robot 200 are out of view and are not shown in FIG. 2. The end-of-arm tool on the robot 200 is a single suction cup gripper 210 as shown. The robot controller and the workpiece are omitted from FIG. 2 for simplicity. The single suction cup gripper 210 is preferable over the finger-style gripper 120 of FIG. 1 for some applications—such as where the workpieces have one or more flat surfaces suitable for suction gripping, and where the workpieces are initially piled together in a bin such that a finger-style gripper would likely collide with other parts in the pile while attempting to grasp one part. The single suction cup gripper 210 is coupled to a vacuum source by a vacuum line (not shown), and is activated by applying a vacuum “pressure” (that is, a partial vacuum causing a negative gauge pressure) when the suction cup gripper 210 is applied to the workpiece. Typically a vacuum switch serves as a part presence sensor for suction cup grippers.

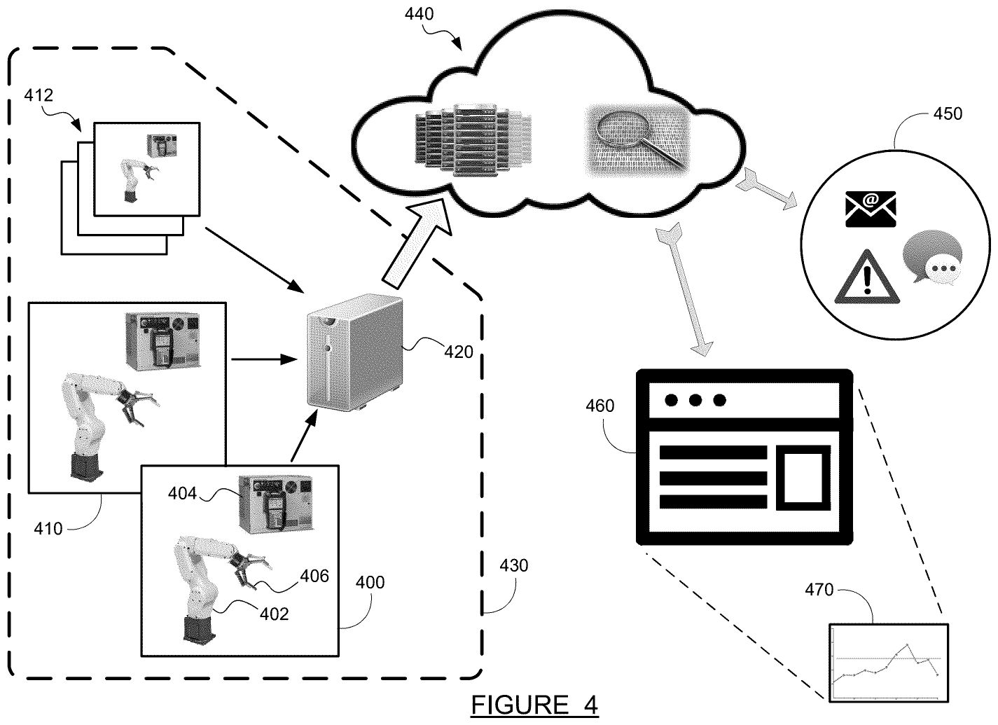

FIG. 3 is an illustration of a vacuum gripper tool comprising a suction cup grid which may be used as a robot end-of-arm tool. A vacuum gripper tool 300 includes a plurality of suction cups 302 arranged in a pattern. The pattern on the suction gripper tool 300 is a 6×8 rectangular grid, but other pattern sizes and shapes, such as circular, may be used. The vacuum gripper tool 300 is typically used to pick up large items with flat surfaces—particularly boxes, but also other types of workpieces. The pattern of suction cups 302 may be divided into a plurality of zones, such as zones 310, 312 and 314 shown. Each of the zones 310, 312 and 314 may be coupled to the vacuum source by its own vacuum line. For this reason, it is desirable and possible to diagnose gripper performance problems by zone in the vacuum gripper tool 300. This topic is discussed further below.

Many other designs of suction cup gripper tools are also available—including rigid arms with multiple suction cups on each arm, and different shapes and sizes of suction cup grids. Most of these designs are physically or logically divided into zones, where each zone may be supplied by its own separate vacuum line.

Like any other type of mechanical component, grippers such as the mechanical finger-style gripper 120, the single suction cup gripper 210 and the vacuum gripper tool 300 are susceptible to wear and tear leading to an eventual degradation in performance and/or outright failure. Until now, it has been common practice to simply replace grippers when they fail—that is, when they fail to pick up parts or drop parts due to breakage or jamming of a mechanical component, or a leak in a vacuum line or suction cup, for example. Unfortunately, gripper failures require a production operation to be shut down for repair or replacement of the failed device. This system downtime is costly to the robot operator, as production time is lost. The techniques of the present disclosure have been developed to allow the proactive monitoring of gripper health, and the performance of preventive maintenance when needed to prevent gripper failure. In one embodiment, the gripper health is evaluated by analyzing the time it takes for a gripper to respond to a grip or ungrip command.

The time it takes for a gripper to respond to a grip or ungrip command is referred to as grip or ungrip response time, and collectively known as gripper timing data. Grip response time may be described as the elapsed time between when a “grip” command signal is issued by the robot controller until the grip task is confirmed as being accomplished. In other words, the grip timer starts when the grip command is issued and the timer stops when the grip is confirmed. Similarly, ungrip response time may be described as the elapsed time between when an “ungrip” command signal is issued by the robot controller until the ungrip task is confirmed as being accomplished.

The grip task and the ungrip task may be confirmed as being accomplished in a variety of ways. In one embodiment, a part presence sensor is used to detect the presence or absence of a part/workpiece in proximity to the gripper. The part presence sensor may be a contactless design (such as inductive or capacitive), or any other type. In another embodiment, camera images or data from other sensors (infrared, lidar, etc.) may be used to detect part presence. The camera images or data from other sensors may also be used to directly detect gripper actuation (such as fingers opening or closing), and the grip/ungrip response time determined from this data.

Still other methods may be used to confirm that the grip and ungrip tasks have been accomplished. In the case of a servo-controlled gripper, motor output power may be limited to prevent the damage of parts. Servo position encoder readings can be used to detect the contact between the gripper and the part. The grip timer is stopped and the timing value is measured when the encoder stops advancing due the contact resistance and limited motor torque. In the case of vacuum grippers, the pressure in the vacuum line(s) can be measured, where a sharp decrease in gauge pressure indicates a part has been attached to a suction cup, and the timing of the gauge pressure change used to stop the grip timer. A combination of the grip/ungrip confirmation techniques discussed above may also be used—either as redundant confirmations, or in a combined mode.

Regardless of the technique used to confirm that a grip command or an ungrip command has been completed, the grip response times and ungrip response times can be used to monitor gripper health. Dropped parts counts may also be recorded, along with grip/ungrip response times, as an indication of gripper performance and health.

FIG. 4 is an illustration of a system for proactively monitoring the health of robot end-of-arm tools based on timing of response to gripping commands, according to an embodiment of the present disclosure. A robot system 400 includes a robot 402 and a controller 404 as discussed earlier. The robot 402 is fitted with a gripper 406 for performing an operation such as picking up a part and moving the part to a different location and a prescribed orientation. The gripper 406 is illustrated as a finger-style gripper, but could be any type of gripper used as an end-of-arm tool—including servo-driven mechanical grippers, single suction cup grippers and vacuum gripper tools. The gripper 406 is fitted with a part presence sensor (not shown)—such as the part presence sensor 122 illustrated in FIG. 1, and as discussed throughout the present disclosure.

The robot system 400 operates at a facility 430, such as a manufacturing facility or assembly plant. A robot system 410 also operates at the facility 430. A plurality of other robot systems 412 typically also operate at the facility 430. The robot systems 400, 410 and 412 are illustrated the same, but they may include a mix of different types of robots using different types of grippers for different operations. Any combination of types of robots and grippers may be employed.

Each of the robot systems 400, 410 and 412 may be configured to record and send gripper timing data as needed. The configuration of each robot, through the robot controller, includes enabling or disabling the overall gripper timing function, and defining specifics such as gripper ID, gripper name, identification of I/O ports, and optionally the definition of timing thresholds which may be used to trigger an alert notification. When the gripper timing function is enabled, appropriate routines are executed in the robot controller operating system (such as KAREL) to start and stop the timers based on signal changes (from a part presence sensor, for example) as discussed above.

The robot systems 400, 410 and 412 all communicate with a data collection device 420. The data collection device 420 is typically a computer or server with ample data storage. The robot controllers of each of the robot systems 400, 410 and 412 transfer their gripper timing data to the data collection device 420 on a real-time or periodic basis. For example, the robot controllers may transfer their gripper timing data to the data collection device 420 after every grip and ungrip event, or once every minute, or any other basis with a suitably short cycle. In a preferred embodiment, response times for every grip command and every ungrip command are recorded by the robot controller and communicated to the data collection device 420.

The data collection device 420 collects gripper timing data for all of the robot systems at the facility 430, where the data collection device 420 and the robot systems 400, 410 and 412 are all typically connected to a local area network running at the facility 430. The connections may be hard-wired, wireless, or a combination thereof.

The data collection device 420 periodically communicates all of the gripper timing data for the robot systems 400, 410 and 412 to a data analytic center 440. The data analytic center 440 is a computing center “in the cloud” (accessible from the Internet) with one or more server computers and data storage capability. The data collection device 420 may communicate all of its gripper timing data to the data analytic center 440 as it is received, or every few minutes, or every half hour, every hour, or any other suitable time period. The gripper timing data is stored separately for each individual gripper, both on the data collection device 420 and at the data analytic center 440. The collection of gripper timing data from the robot systems 400, 410 and 412, and the processing at the cloud-based data analytic center 440, represents an “Internet of things” (IoT) type of system.

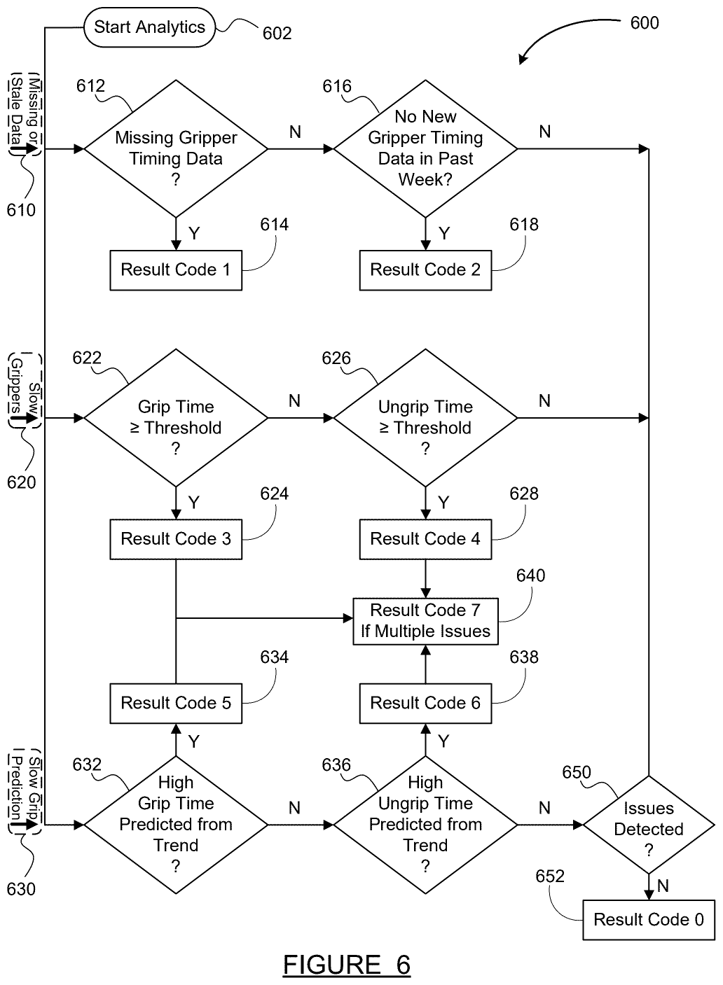

The data analytic center 440 analyzes the gripper timing data for all grippers for which it has received data. Computations performed at the data analytic center 440 for each gripper include identifying maximum response times, and computing averages and trends over different time periods. In addition, several checks are performed periodically (such as each hour) to identify any issues with gripper performance. These checks to identify issues are discussed in detail below with respect to FIG. 6. If any issues are identified, one or more alert notifications 450 are sent by the data analytic center 440. The alert notifications 450 may include text messages and/or emails to key individuals at the facility 430, communications to the individual robot controller associated with the gripper which has the issue, or other types of alerts and notices. The intention of the alert notifications 450 is to provide immediate notification to the appropriate individuals that one or more grippers have performance issues needing attention.

The data analytic center 440 also provides gripper timing data analysis summaries and statistics to a web portal 460. The web portal 460 is a dedicated, secure private website where personnel from the facility 430, with appropriate authentication, can view the gripper timing data for all of the robot systems 400, 410 and 412. The web portal 460 provides gripper timing data in the form of graphs 470 (such as average grip response times by hour or by day, for example). The web portal 460 also provides gripper timing data in other forms as suitable and convenient—including tables, listings of averages and trends, etc. Any open issues are also highlighted on the web portal 460.

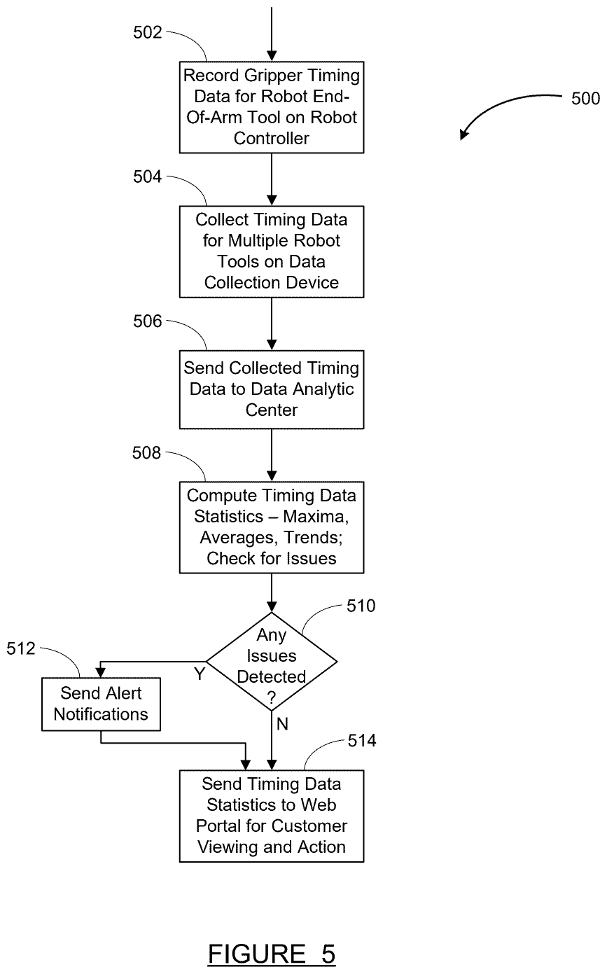

FIG. 5 is a flowchart diagram 500 of a method for proactively monitoring the health of robot end-of-arm tools based on timing of response to gripping commands, according to an embodiment of the present disclosure. The method of the flowchart diagram 500 corresponds directly to the system shown in FIG. 4.

At box 502, gripper timing data are recorded on the robot controller (e.g., the controller 404) for the end-of-arm tool (e.g., the gripper 406) on the robot (e.g., the robot 402). Generally, the grip response time and ungrip response time is recorded for each grip or ungrip task by the robot controller, using the various detection means discussed above. At box 504, gripper timing data are collected on the data collection device 420. The timing data may be collected in real time for all robot grippers in a facility, as discussed earlier. At box 506, the gripper timing data is sent from the data collection device 420 at the facility 430 to the data analytic center 440.

At box 508, computations are performed at the data analytic center 440 on the gripper timing data. The computations may be performed hourly, or at any other suitable interval. The computations are performed for each individual gripper—including identification of maximum grip/ungrip times, calculation of averages and trends over time, etc. Aggregate calculations for the entire facility may also be performed.

At decision diamond 510, it is determined whether any issues are identified in the gripper timing data. Details of the checks and determinations made at the decision diamond 510 are discussed below with respect to FIG. 6. If any issues exist (such as grip times exceeding a threshold), then at box 512 the alert notifications 450 are sent to inform key personnel (plant manager, manufacturing engineer, robot operator, etc.) of the issue and the potential need for preventive maintenance.

At box 514, gripper timing data statistics are provided to the web portal 460 for customer viewing and action. The gripper timing data on the web portal 460 may include graphs and tables containing individual data points, averages, trends, maxima, etc. Gripper timing issues are also highlighted.

Through the combination of the alert notifications 450 and the web portal 460, the key personnel at the facility 430 have all of the information they need to proactively monitor end-of-arm tool health. Preventive maintenance can then be efficiently and cost-effectively performed on any grippers which are experiencing longer than desired grip response times and/or ungrip response times.

FIG. 6 is a flowchart diagram 600 of a method for identifying any issues with the health of robot end-of-arm tools based on analysis of gripping command response timing data, according to an embodiment of the present disclosure. The flowchart diagram 600 includes the issue-checking steps described above at the decision diamond 510 of FIG. 5.

Analytics and issue checking for an individual gripper begin at start point 602. The initiation of analytics at the start point 602 may be triggered once per hour, or on any other suitable time schedule. On the row indicated at 610, the existence of current timing data for the gripper is verified. At decision diamond 612, it is determined if gripper timing data is missing and if so, a corresponding result code value (1) is set at box 614. At decision diamond 616, it is determined if gripper timing data is stale (such as no new data in past week) and if so, a corresponding result code value (2) is set at box 618.

On the row indicated at 620, checks are performed for slow actual grip or ungrip times. At decision diamond 622, it is determined if grip times exceed a threshold for the current analytic period (e.g., the past hour) and if so, a corresponding result code value (3) is set at box 624. At decision diamond 626, it is determined if ungrip times exceed a threshold for the current analytic period and if so, a corresponding result code value (4) is set at box 628. Both individual grip/ungrip times and average grip/ungrip time for the past hour may be checked at the decision diamonds 622 and 626. The thresholds (e.g., 200 milliseconds) may be established by the robot operator during the configuration process described earlier, or the thresholds may be automatically calculated based on historical data (such as a certain percentage or a certain number of standard deviations greater than the mean).

On the row indicated at 630, checks are performed for slow predicted grip or ungrip times. At decision diamond 632, it is determined if grip times are trending upward, such that grip times exceeding the threshold are predicted in the near future. If an upward trend leads to a high predicted grip time at the decision diamond 632, then a corresponding result code value (5) is set at box 634. At decision diamond 636, it is determined if ungrip times are trending upward, such that ungrip times exceeding the threshold are predicted in the near future. If an upward trend leads to a high predicted ungrip time at the decision diamond 636, then a corresponding result code value (6) is set at box 638. The upward trend in grip or ungrip times may be detected in the current analytic period (e.g., the current hour's data), or the upward trend may be detected when comparing the average of the current data to the historical average.

At box 640, a result code value of 7 is set if multiple issues exist-that is, if more than one of the result codes 3-6 are set. In general, the rows 610, 620 and 630 are all executed for each analytic cycle. If data is missing or stale on the row 610, then the rows 620 and 630 are not executed. If none of the result codes 1-6 are set, then the process flows to decision diamond 650 where, if no issues have been detected, a result code of 0 is set.

Any non-zero result codes from the flowchart diagram 600 cause an alert notification to be sent identifying the issue. In addition, calculated data such as hourly average grip and ungrip times are written to a table and made available to the web portal. Raw data and summary data are also made available to the web portal for viewing by facility personnel as appropriate.

Other types of analysis may also be performed in the steps of the flowchart diagrams 500 and 600. For example, grip times and ungrip times may be recorded, stored and analyzed by zone in multi-zone vacuum gripper tools. In this case, if a slow grip time or inadequate grip pressure is detected in one zone, then the alert notification and the portal entries identify the gripper and the specific zone which is experiencing the issue. Issues may also be detected and reported based on dropped parts counts instead of grip/ungrip times.

The data analytic center 440 is configured to receive data from many different facilities besides the facility 430. In a typical arrangement, each robot customer (a company which makes things using the robots) has several facilities, each providing data to the analytic center 440. Data is managed by facility and by customer so that it may be stored, displayed and protected in the appropriate fashion. That is, the web portal 460 is only accessible by the robot customer which owns the facility 430. Other robot customers whose data is processed in the data analytic center 440 have their own independent web portals to view that gripper timing data. Furthermore, the data analytic center 440 and the web portal 460 may be part of a larger integrated system for predictive robot health and preventive maintenance.

Throughout the preceding discussion, various computers and controllers are described and implied in connection with the disclosed methods and systems. It is to be understood that the software applications and modules of these computers and controllers are executed on one or more computing devices having a processor and a memory module. In particular, this includes processors in the robot controllers 110 and 404, the data collection device 420 and the computer(s) in the data analytic center 440. Specifically, the processor in the controllers 110 and 404 is configured to record gripper timing data and other performance data associated with the gripper on the robot, the processor in the data collection device 420 is configured to receive the gripper data from the controllers and send the data to the data analytic center 440, and the processors in the computer(s) in the data analytic center 440 are configured to analyze gripper health based on the timing data, send notifications of issues, and provide data to the web portal.

As discussed above, mechanical, servo, or vacuum grippers may fail to grip or ungrip fast enough as a result of age, overuse, lack of lubrication for the actuator, or low vacuum pressure caused by leaks or torn cups. The disclosed techniques for robot end-of-arm tool health monitoring via gripper timing provide alerts and data which identify gripper issues as soon as they begin to develop. Similar timing techniques may be employed to identify issues with other types of end-of-arm tools. This early identification of issues enables preventive maintenance to be performed before an end-of-arm tool fails, thus allowing robot customers to avoid costly production downtime, and reducing the number of dropped and damaged parts.

While a number of exemplary aspects and embodiments of the techniques for robot end-of-arm tool health monitoring via gripper timing have been discussed above, those of skill in the art will recognize modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A gripper health monitoring method for an industrial robot, said method comprising:
recording, by a robot controller, gripper response times for each grip or ungrip event by a gripper on the robot;
analyzing the gripper response times, by a computer having a processor and memory, to provide analyzed gripper timing data;
identifying any anomalous issues in the gripper response times and the analyzed gripper timing data;
sending alert notifications of any identified issues; and
providing the gripper response times, the analyzed gripper timing data and any identified issues on a web portal for viewing by a robot operator.

2. The method according to claim 1 wherein recording gripper response times includes recording the response times by the robot controller and providing the response times to a data collection device.

3. The method according to claim 2 wherein gripper response times for grippers on other robots are also provided to the data collection device by each of the other robots' controllers, and the gripper response times for all of the robots are communicated from the data collection device to the computer.

4. The method according to claim 3 wherein the data collection device, the computer and the web portal also handle other health status data for all of the robots.

5. The method according to claim 1 wherein the response time for each grip or ungrip event is determined by starting a timer when a grip or ungrip command is issued by the robot controller and stopping the timer when a corresponding grip or ungrip is confirmed to have occurred.

6. The method according to claim 5 wherein the corresponding grip or ungrip is confirmed to have occurred by a part presence sensor detecting proximity of a part to the gripper, or by analyzing signals from a camera or sensor in which the signals depict a position of the part or the gripper or both.

7. The method according to claim 5 wherein the corresponding grip or ungrip is confirmed to have occurred by evaluating a pressure signal from a vacuum line for a vacuum or suction gripper, or a signal from a motor torque or position sensor for a servo-controlled gripper.

8. The method according to claim 1 wherein analyzing the gripper response times includes identifying a maximum grip time and a maximum ungrip time for a current analysis data period, computing an average grip time and an average ungrip time for the current analysis data period, and computing a grip time trend line slope and an ungrip time trend line slope for the current analysis period.

9. The method according to claim 8 wherein the current analysis data period has a duration in a range of a half hour to four hours.

10. The method according to claim 8 wherein identifying any anomalous issues includes identifying missing or stale gripper response times, identifying a maximum grip time, a maximum ungrip time, an average grip time or an average ungrip time exceeding a threshold value, and identifying a grip time trend line slope or an ungrip time trend line slope exceeding a trend line slope threshold value.

11. The method according to claim 1 wherein the gripper on the robot is a mechanical finger-style gripper, a servo-motor driven gripper, a single suction cup gripper or a vacuum gripper tool having a plurality of suction cups.

12. The method according to claim 11 wherein the alert notifications for a vacuum gripper tool identify one or more zones of suction cups which have the identified issue.

13. The method according to claim 1 wherein sending alert notifications includes sending one or more of text messages, instant messages, emails and notifications to the robot controller.

14. A health monitoring method for an end-of-arm tool on an industrial robot, said method comprising:
recording, by a robot controller, response times for a start and stop of each task performed by the end-of-arm tool;
analyzing the response times, by a computer having a processor and memory, to provide analyzed tool timing data;
identifying any anomalous issues in the response times and the analyzed tool timing data;
sending alert notifications of any identified issues; and
providing the response times, the analyzed tool timing data and any identified issues on a web portal for viewing by a robot operator.

15. A gripper health monitoring system for industrial robots, said system comprising:
one or more robots, each robot having a gripper as an end-of-arm tool;
a robot controller in communication with each robot, each controller having a processor and memory configured for recording gripper response times for each grip or ungrip event by the gripper on the robot;
a data collection device in communication with the robot controllers and receiving the gripper response times for each of the robots; and
a computer having a processor and memory, said computer periodically receiving the gripper response times from the data collection device, where the computer is configured for;
analyzing the gripper response times for each individual gripper to provide analyzed gripper timing data;
identifying any anomalous issues in the gripper response times and the analyzed gripper timing data for each individual gripper;
sending alert notifications of any identified issues; and
providing the gripper response times, the analyzed gripper timing data and any identified issues on a web portal for viewing by a robot operator.

16. The system according to claim 15 wherein the data collection device, the computer and the web portal also handle other health status data for all of the robots.

17. The system according to claim 15 wherein the response time for each grip or ungrip event is determined by starting a timer when a grip or ungrip command is issued by the robot controller and stopping the timer when a corresponding grip or ungrip is confirmed to have occurred.

18. The system according to claim 17 wherein the corresponding grip or ungrip is confirmed to have occurred by a part presence sensor detecting proximity of a part to the gripper, or by analyzing signals from a camera or sensor in which the signals depict a position of the part or the gripper or both.

19. The system according to claim 17 wherein the corresponding grip or ungrip is confirmed to have occurred by evaluating a pressure signal from a vacuum line for a vacuum or suction gripper, or a signal from a motor torque or position sensor for a servo-controlled gripper.

20. The system according to claim 15 wherein analyzing the gripper response times includes identifying a maximum grip time and a maximum ungrip time for a current analysis data period, computing an average grip time and an average ungrip time for the current analysis data period, and computing a grip time trend line slope and an ungrip time trend line slope for the current analysis period.

21. The system according to claim 20 wherein identifying any anomalous issues includes identifying missing or stale gripper response times, identifying a maximum grip time, a maximum ungrip time, an average grip time or an average ungrip time exceeding a threshold value, and identifying a grip time trend line slope or an ungrip time trend line slope exceeding a trend line slope threshold value.

22. The system according to claim 15 wherein the gripper on the robot is a mechanical finger-style gripper, a servo-motor driven gripper, a single suction cup gripper or a vacuum gripper tool having a plurality of suction cups, and where the alert notifications for a vacuum gripper tool identify one or more zones of suction cups which have the identified issue.
